(19) United States
(12) Patent Application Publication
(10) Pub. No.: US 2017/0054964 A1
(43) Pub. Date: Feb. 23, 2017

(54) METHOD AND ELECTRONIC DEVICE FOR PLAYING SUBTITLES OF A 3D VIDEO, AND STORAGE MEDIUM

(71) Applicants: LE HOLDINGS (BEIJING) CO., LTD., Beijing (CN); LE SHI ZHI XIN ELECTRONIC TECHNOLOGY (TIAN JIN) LIMITED, Tianjin (CN)

(72) Inventor: Xuan SHI, Tianjin (CN)

(21) Appl. No.: 15/226,202

(22) Filed: Aug. 2, 2016

Related U.S. Application Data
(63) Continuation of application No. PCT/CN2016/082226, filed on May 16, 2016.

(30) Foreign Application Priority Data
Aug. 17, 2015 (CN) 201510505890.6

(51) Int. Cl. H04N 13/00

(52) U.S. Cl. CPC H04N 13/0062; H04N 13/0051

(57) ABSTRACT

The disclosure provides a method and electronic device for playing subtitles of a 3D video, and a storage medium. The method includes: obtaining subtitles in at least one timestamp of the 3D video; determining whether subtitle contents in the same timestamp among the obtained subtitles are duplicated; if so, then playing the 3D video by playing the subtitle of the 3D video as 3D subtitles; and otherwise, playing the 3D video by processing the subtitles of the 3D video into 3D subtitles, and then playing the 3D subtitles. With the technical solution according to the disclosure, a display effect of the 3D video can be improved.

### CROSS REFERENCE TO RELATED APPLICATIONS

This application is a continuation of International Application No. PCT/CN2016/082226, filed on May 16, 2016, which is based upon and claims priority to Chinese Patent Application No. 201510505890.6, filed on Aug. 17, 2015, the entire contents of which are incorporated herein by reference.

### TECHNICAL FIELD

The present disclosure relates to the field of video processing, and particularly to a method and apparatus for playing subtitles of a 3D video, and a storage medium.

### BACKGROUND

3-Dimension (3D) videos are widely popular to video users because they can provide the users with a visual experience as if their users were personally on the scene. At present, a variety of video terminals (e.g., smart TV sets, smart mobile phones, etc.) can support for playing the 3D videos.

Subtitles of a 3D video are an indispensable component while the 3D video is being played. In the prior art, the subtitles of the 3D video are played at present typically by processing the 2D subtitles of the 3D video into 3D subtitles, and then playing the 3D video with the 3D subtitles.

However the solution above is only applicable to the 3D video with the 2D subtitles. Since there has been absent a unified standard in the industry, the subtitles of the 3D video may be 2D subtitles or 3D subtitles. If the subtitles are 3D subtitles, then the original 3D subtitles will undergo a processing from 2D subtitles into 3D subtitles and then played, so that the subtitles may be displayed poorly, for example, the subtitles may be displayed distorted or blurred. Particularly subtitle contents in the same timestamp have only one copy in the 2D subtitles, and two copies in the 3D subtitles, for example, if subtitle contents in a timestamp A are four Chinese characters “ [symbol] ” then there will be only these four Chinese characters in the timestamp A in the 2D subtitles, and eight Chinese characters in the timestamp A in the 3D subtitles (i.e., two copies of “ [symbol] ”). Thus the 2D subtitles are processed into the 3D subtitles by duplicating the subtitle contents in the 2D subtitles, thus resulting in two duplicates of the subtitle contents. If the 3D subtitles undergo the processing from 2D subtitles into 3D subtitles, then there will be four duplicates of the subtitle contents, so that the subtitles being played may be displayed poorly due to the redundant duplicates of the subtitle contents.

### SUMMARY

The disclosure provides a method and apparatus for playing subtitles of a 3D video so as to address the problem in the prior art of poorly displaying 3D subtitles since the 3D subtitles undergo a processing from 2D subtitles into 3D subtitles.

Particular technical solutions according to the embodiments of the disclosure are as follows:

In an aspect, an embodiment of the disclosure provides a method for playing subtitles of a 3D video, at an electronic device with a display, the method including:

obtaining subtitles in at least one timestamp of the 3D video;

determining whether subtitle contents in the same timestamp among the obtained subtitles are duplicated;

if so, then playing the 3D video by playing the subtitles of the 3D video as 3D subtitles; and

otherwise, playing the 3D video by processing the subtitles of the 3D video into 3D subtitles, and then playing the 3D subtitles.

In another aspect, an embodiment of the disclosure provides an electronic device, the electronic device including:

at least one processor; and

a memory communicably connected with the at least one processor for storing instructions executable by the at least one processor, wherein execution of the instructions by the at least one processor causes the at least one processor to:

obtain subtitles in at least one timestamp of the 3D video;

determine whether subtitle contents in the same timestamp among the obtained subtitles are duplicated;

if so, play the 3D video by playing the subtitles of the 3D video as 3D subtitles; and

otherwise, play the 3D video by processing the subtitles of the 3D video into 3D subtitles, and then playing the 3D subtitles.

In another aspect, an embodiment of the disclosure provides a non-transitory computer-readable storage medium storing executable instructions that, when executed by an electronic device, cause the electronic device to:

obtain subtitles in at least one timestamp of the 3D video;

determine whether subtitle contents in the same timestamp among the obtained subtitles are duplicated;

if so, play the 3D video by playing the subtitles of the 3D video as 3D subtitles; and

otherwise, play the 3D video by processing the subtitles of the 3D video into 3D subtitles, and then playing the 3D subtitles.

In the embodiments of the disclosure, the subtitles of the 3D video can be identified as 2D subtitles or 3D subtitles by determining whether the subtitle contents in the same timestamp among the obtained subtitles are duplicated, so that the different subtitles can be processed differently, that is, if the subtitles are 2D subtitles, then the 2D subtitles will be processed into 3D -subtitles as in the prior art so that the 2D subtitles are converted into the 3D subtitles, and the 3D subtitles are played; and if the subtitles are 3D subtitles, then, the 3D subtitles will be played and no processing from 2D subtitles into 3D subtitles is performed. Accordingly the 3D subtitles can be played and displayed correctly without a processing from 2D subtitles into 3D subtitles in the prior art, thus improving a display effect of the 3D subtitles.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is an exemplary flow chart of a method for playing subtitles of a 3D video according to an embodiment of the disclosure;

FIG. 2 is a schematic diagram of horizontally arranged graph subtitles according to an embodiment of the disclosure;

FIG. 3 is a schematic diagram of vertically arranged graph subtitles according to an embodiment of the disclosure;

FIG. 4 is a schematic diagram of an apparatus for playing subtitles of a 3D video according to an embodiment of the disclosure; and

FIG. 5 is a schematic diagram of an electronic device for playing subtitles of a 3D video according to an embodiment of the disclosure.

### DETAILED DESCRIPTION

In order to make the objects, technical solutions, and advantages of the embodiments of the disclosure more apparent, the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

The inventors have identified from their studies that since subtitles of a 3D video are played as 2D subtitles in the prior art so that if the subtitles of the 3D video are originally 3D subtitles, then the resulting subtitles may be displayed poorly. In view of this, in a technical solution according to an embodiment of the disclosure, firstly it is determined whether the subtitles of the 3D video are 2D subtitles or 3D subtitles, and if the subtitles are 2D subtitles, then the 2D subtitles will be processed into 3D subtitles, and then the 3D subtitles will be played; or if the subtitles are 3D subtitles, then the 3D subtitles will be played directly, no processing from 2D subtitles to 3D subtitles is performed. Thus the embodiment of the disclosure can improve the effect of displaying the subtitles of the 3D video over the prior art; and also in the technical solution according to the embodiment of the disclosure, no processing from 2D subtitles into 3D subtitles is performed, thus saving processing resources.

A method for playing subtitles of a 3D video according to the disclosure will be described below in details with reference to particular embodiments.

### First Embodiment

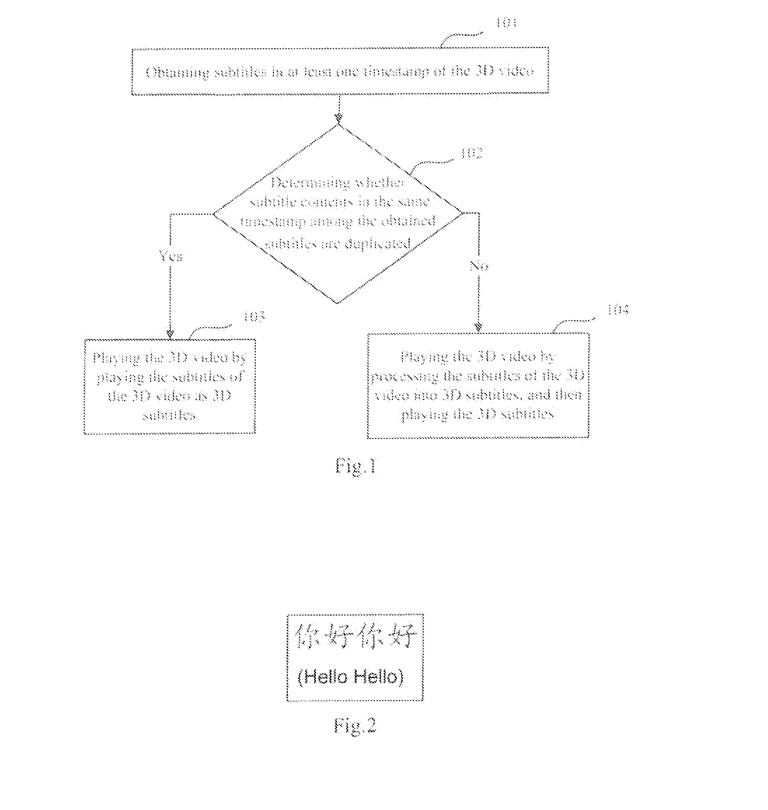

As illustrated FIG. 1, there is an exemplary flow chart of a method for playing subtitles of a 3D video according to an embodiment of the disclosure, where the method includes the followings operations:

Operation 101: Obtaining subtitles in at least one timestamp of the 3D video.

Here in an embodiment, the operation 101 can be performed before the 3D video is played, or the operation 101 can be performed when playing of the 3D video is started. Of course, if playing of subtitles in a first timestamp is started only after the 3D video has been played for a period of time, then the operation 101 can alternatively be performed after playing of the 3D video is started, and before the subtitles in the first timestamp is played in an embodiment of the disclosure.

Here in an embodiment, if there is a subtitle file, then subtitles in at least one timestamp can be obtained from the subtitle file of the 3D video; and if there is no subtitle file, but subtitle data are in the same data file as video data, and the data file is parsed for the subtitle data so that the subtitle data are stored in a memory, then subtitles in at least one timestamp will be obtained from the memory.

Here in an embodiment the subtitle file can be determined by searching for a file in a preset subtitle file format e.g., the SubStation Alpha (SSA), the Advanced SSA, the SaMi (SMI), the SubRip Text (SRT) the SUB, the Sonic Scenarist (SST), etc., where subtitle data in the SUB format consists of a subtitle picture file (a sub document) and a subtitle index file (an .idx document). A sub document can include subtitles in a number of languages, and can be invoked by the .idx document. These two files are common in DVD-VIDEO, but they are integrated into VOB in DVD so that the subtitle file will be obtained by separating VOB in software.

Operation 102: Determining whether subtitle contents in the same timestamp among the obtained subtitles are duplicated.

Here, if subtitles in one timestamp are obtained, then “whether subtitle contents in the same timestamp are duplicated” in the operation 102 will be determined by determining whether the obtained subtitle contents in the one subtitle timestamp are duplicated.

If subtitles in at least two timestamps are obtained, then “whether subtitle contents in the same timestamp are duplicated” in the operation 102 will be determined by firstly determining whether the obtained subtitle contents in the respective timestamps are duplicated, and then synthesizing respective determination results, a particular implementation of which will be described below.

Operation 103: If so, playing the 3D video by playing the subtitles of the 3D video as 3D subtitles.

Operation 104: If not, playing the 3D video by processing the subtitles of the 3D video into 3D subtitles, and then playing the 3D subtitles.

Here in an embodiment of the disclosure, the subtitle contents are substantially character contents, so it can be determined whether the subtitle contents are duplicated in the operation 102 by determining whether there are duplicated character contents in the same timestamp. Particularly the operation 102 can be performed in the following two approaches:

### First Approach

Operation A1: Calculating a matching degree between character strings in a first half of text information and a second half of text information in the subtitles in the same timestamp among the obtained subtitles.

Operation A2: Determining whether the calculated matching degree between the character strings is more than or equal to a preset matching degree.

Operation A3: If so, determining that the subtitle contents in the same timestamp among the obtained subtitles are duplicated.

Operation A4: If not, determining that the subtitle contents in the same timestamp among the obtained subtitles are not duplicated.

Here in an embodiment, if subtitles in at least two timestamps are obtained in the operation 101, then the operation A1 can be performed in the following operations:

Operation A11: For the obtained subtitles in each timestamp, determining whether characters at the same position in a first half of text information and a second half of text information in the subtitles are identical, and obtaining the number of characters determined to be identical.

Operation A12: For the obtained subtitles in each timestamp, calculating a first ratio of the number of characters in the subtitles, which are determined to be identical, to a half of the number characters in the subtitles, and determining the first ratio as a character similarity of the subtitles.

Operation A13: Determining the matching degree between the character strings in one of the following three approaches:

1) The average of the respective character similarities calculated in the operation A12 are calculated as the matching degree between the character strings;

2) The number of character similarities greater than or equal to a preset threshold is counted, and a second ratio of this number to the number of timestamp in the obtained subtitles in at least one timestamp is calculated as the matching degree between the character strings; and

3) The largest or least one of the respective character similarities calculated in the operation A12 is determined as the matching degree between the character strings.

It shall be noted that any approach, in which the matching degree between the character strings indicating whether the subtitle contents in the same timestamp are duplicated is determined according to the calculation result in the operation A12, will be applicable to the embodiment of the disclosure, so the embodiment of the disclosure will not be limited to.

### Second Approach

Operation B1 Counting the number of times that a preset character string in text information of the subtitles in the same timestamp among the obtained subtitles is duplicated where the preset character string is a character string consisted of a preset number of characters ranked higher in a sequential order of characters in the text information.

For example, of subtitle contents of 2D subtitles are “ [symbol] , [symbol] ”, then text information of the 2D subtitles will include “ [symbol] , [symbol] ”, and a sequential order of characters in the text information is “ [symbol] , [symbol] ”; and if the preset number is 2, then the character string consisted of the preset number of characters ranked higher will be “ [symbol] ” (that is, the preset character string is “ [symbol] ”). Thus the number of times that the two characters of “ [symbol] ” are duplicated in the text information (i.e., “ [symbol] , [symbol] ”) is determined in the operation B1. Apparently the number of times that the two characters are duplicated is determined as 1.

Operation B2: Determining whether the number of times that the preset character string is duplicated is more than a preset number of times that the preset character string is duplicated.

Operation B3: If so, concluding that the subtitle contents in the same timestamp among the obtained subtitles are duplicated.

Operation B4: If not, determining that the subtitle contents in the same timestamp among the obtained subtitles are duplicated.

Here in an embodiment of the disclosure, if subtitles in at least two timestamps are obtained in the operation 101, the operation B1 can be performed in the following operations:

Operation B15: For a obtained subtitles in each timestamp, determining the number of times that the preset character string consisting of a preset number of characters ranked higher in a sequential order of characters in the subtitles is cycled in the subtitles.

Here the number of times that the preset character string is cycled being 1 indicates that there is only one preset character string in the subtitles; and the number of times that the preset character string is cycled being 2 indicates that there are two preset character strings in the subtitles.

Operation B12: Determining the number of times that the preset character string is duplicated in one of the following two approaches:

1) The average of the respective numbers of times that the preset character string is duplicated, calculated in the operation B11 is calculated as the number of times that the preset character string is duplicated; and

2) The count of the numbers of times that the preset character string is duplicated, being 1 or more than 1 is calculated, and a third ratio of the count to the number of timestamps in the obtained subtitles in the at least one timestamp is calculated as the number of times that the preset character string is duplicated.

It shall be noted that any approach, in which the number of times that the preset character string is duplicated, indicating whether the subtitle contents in the same time stamp are duplicated, is determined according to the determination result in the operation B11, will be applicable to the embodiment of the disclosure, so the embodiment of the disclosure will not be limited thereto.

Here in an embodiment of the disclosure, the subtitles of the 3D video include text subtitles and graph subtitles, and if the obtained subtitles are graph subtitles, then in order to perform the operation 102 in the first .approach or the second approach, before the operation 102, the method further includes: determining whether the obtained subtitles are graph subtitles; and if so, then identifying characters from the graph subtitles, and obtaining text information in the graph subtitles.

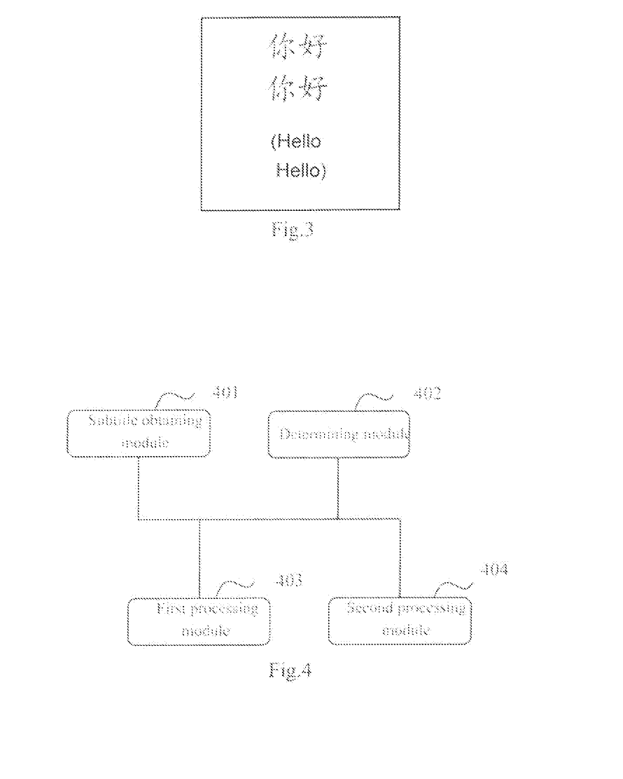

Here in an embodiment of the disclosure, in order to play a picture of the 3D video with a 3D effect, the same picture being played includes a left-eye image, and a right-eye image, both of which are typically arranged horizontally or vertically. Duplicated subtitle contents in the same timestamp among the 3D subtitles are arranged in the same way as the left-eye image, and the right-eye image. For example, if the subtitle contents are “ [symbol] ”, then the graph subtitles will be arranged horizontally as schematically illustrated in FIG. 2, and vertically as schematically illustrated in FIG. 3. Since the graph subtitles among the 3D subtitles include the same subtitle contents, then if the obtained subtitles are graph subtitles, then it can alternatively be determined whether subtitle contents in the same timestamp among the obtained subtitles are duplicated, by comparing images, particularly as follows:

Before the operation 102 is performed, it is determined whether the obtained subtitles are graph subtitles, and then the operation 102 can be performed particularly in the following operations:

Operation C1: If the obtained subtitles are graph subtitles, obtaining a mode in which a left-eye image, and a right-eye image in the same picture of the 3D video are arranged, where the arrangement mode is vertical arrangement or horizontal arrangement.

Operation C2: Dividing the graph subtitles in the same timestamp among the obtained subtitles into two halves according to the obtained arrangement mode.

Operation C3: Comparing images in the two halves of the graph subtitles in the same timestamp in the obtained subtitles, and to determine a graph similarity.

Here in an embodiment, the images are compared, for example, by normalizing the values of pixels in the two halves of the graph subtitles, and then, calculating the differences between the values of the pixels at the same positions, calculating the average of the differences between the values of the pixels at the respective positions, and determining the difference between the average and 1 as the graph similarity. Of course, the images in the two halves of the graph subtitles can be compared otherwise as in the prior art, so the embodiment of the disclosure will not be limited thereto.

Of course, if subtitles in at least two timestamps are obtained, then the graph similarity will be calculated in the operation C3 as a function of results of comparing images in two halves of graph subtitles in the respective timestamps, for example, the average of the respective comparison results, the largest or least one of the comparison results, or the weighted average of the comparison results can be determined as the graph similarity in the operation C3, so the embodiment of the disclosure will not be limited thereto.

Operation C4: Determining whether the determined graph similarity is more than or equal to a preset similarity.

Operation C5: If so, concluding that the subtitle contents in the same timestamp among the obtained subtitles are duplicated.

Operation C6: If so, concluding that the subtitle contents in the same timestamp among the obtained subtitles are not duplicated.

In summary, in the embodiment of the disclosure, the subtitles of the 3D video can be identified as 2D subtitles or 3D subtitles by determining whether the subtitle contents in the same timestamp among the obtained subtitles are duplicated, so that the different subtitles can be processed differently, that is, if the subtitles are ID subtitles, then the 2D subtitles will be processed into 3D subtitles as in the prior art, so that the 2D subtitles is converted into the 3D subtitles, and the 3D subtitles are played; and if the subtitles are 3D subtitles, then the 3D subtitles will be played while no processing from 2D subtitles into 3D subtitles is performed. Accordingly the 3D subtitles can be played and displayed correctly without, a processing from 2D subtitles into 3D subtitles in the prior art, thus improving the display effect of the 3D subtitles.

### Second Embodiment

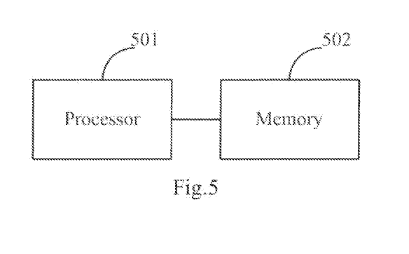

Based upon the same inventive idea, an embodiment of the disclosure further provides an apparatus for playing subtitles of a 3D video, as illustrated in FIG. 4, which includes:

A subtitle obtaining module 401 is configured to obtain subtitles in at least one timestamp of the 3D video;

A determining module 402 is configured to determine whether subtitle contents in the same timestamp among the obtained subtitles are duplicated;

A first processing module 403 is configured, if a determination result of the determining module is Yes, to play the 3D video by playing the subtitles of the 3D video as 3D subtitles; and

A second processing module 404 is configured, if the determination result of the determining module is No, to play the 3D video by processing the subtitles of the 3D video into 3D subtitles, and then playing the 3D subtitles.

Here in an embodiment, the determining module includes:

A first calculating unit is configured to calculate a matching degree between character strings in a first half of text information and a second half of text information in the subtitles in the same timestamp among the obtained subtitles;

A first determining unit is configured to determine whether the calculated matching degree between the character strings is more than or equal to a preset matching degree;

A first determining unit is configured, if a determination result of the first determining unit is Yes, to determine that the subtitle contents in the same timestamp among the obtained subtitles are duplicated; and

A second determining unit is configured, if the determination result of the first determining unit is No, to determine that the subtitle contents in the same timestamp among the obtained subtitles are not duplicated.

Here in an embodiment, the determining module includes:

A second counting unit is configured to count the number of times that a preset character string in text information of the subtitles in the same timestamp among the obtained subtitles is duplicated, where the preset character string is a character string consisting of a preset number of characters ranked higher in a sequential order of characters in the text information;

A second determining unit is configured to determine whether the number of times that the preset character string is duplicated is more than a preset number of times that the preset character string is duplicated;

A third determining unit is configured, if a determination result of the second determining unit is Yes, to determine that the subtitle contents in the same timestamp among the obtained subtitles are duplicated; and

A fourth determining unit is configured, if the determination result of the second determining unit is No, to determine that the subtitle contents in the same timestamp among the obtained subtitles are not duplicated.

Here in an embodiment, the apparatus further includes:

A first graph subtitle determining module is configured to determine whether the obtained subtitles are graph subtitles, before the determining module determines whether the subtitle contents in the same timestamp among the obtained subtitles are duplicated; and

A character identifying module is configured, if a determination result of the first graph subtitles determining module is Yes, to identify characters from the graph subtitles, and to obtain the text information in the graph subtitles.

Here in an embodiment, the apparatus further includes:

A second graph subtitle determining module is configured, to determine whether the obtained subtitles are graph subtitles, before the determining module determines whether the subtitle contents in the same timestamp among the obtained subtitles are duplicated; and

The determining module includes:

An obtaining unit is configured to obtain a mode in which a left-eye image, and a right-eye image in the same picture of the 3D video are arranged, if a determination result of the second graph subtitle determining module is that the obtained subtitles are graph subtitles, where the arrangement, mode is a vertical arrangement mode or a horizontal arrangement mode;

A dividing unit is configured to divide the graph subtitle in the same timestamp among the obtained subtitles into two halves according to the obtained arrangement mode;

An image comparing unit is configured to compare images in the two halves of the graph subtitles in the same timestamp in the obtained subtitles, and to determine a graph similarity;

A third determining unit is configured to determine whether the determined graph similarity is more than or equal to a preset similarity;

A fifth determining unit is configured, if a determination result of the third determining unit is Yes, to determine that that the subtitle contents in the same subtitle among the obtained subtitles are duplicated; and

A sixth determining unit is configured, if a determination result of the third determining unit is No, to determine that that the subtitle contents in the same timestamp among the obtained subtitles are not duplicated.

Particular implementations of the operations performed by the respective modules in the apparatus according to the embodiment above have been described in details in the embodiment of the method corresponding thereto, so a detailed description thereof will be omitted here.

### Third Embodiment

Based, upon the same inventive idea, an embodiment of the disclosure further provides an electronic device, as illustrated in FIG. 5, which includes:

at least one processor 501 and a memory 502, where there is one processor as an example in FIG. 5.

The memory 502 is communicably connected with the at least one processor for storing instructions executable by the at least one processor, wherein execution of the instructions by the at least one processor causes the at least one processor to:

obtain subtitles in at least one timestamp of the 3D video;

determine whether subtitle contents in the same timestamp among the obtained subtitles are duplicated;

if so, play the 3D video by playing the subtitles of the 3D video as 3D subtitles; and

otherwise, play the 3D video by processing the subtitles of the 3D video into 3D subtitles, and then playing the 3D subtitles.

In one embodiment, the execution of the instructions by the at least one processor further causes the at least one processor to:

calculate a matching degree between character strings in a first half of text information and a second half of text information in the subtitles in the same timestamp among the obtained subtitles;

determine whether the calculated matching degree between the character strings is more than or equal to a preset matching degree;

if so, determine that the subtitle contents in the same timestamp among the obtained subtitles are duplicated; and

otherwise, determine that the subtitle contents in the same timestamp among the obtained subtitles are not duplicated.

In one embodiment, the execution of the instructions by the at least one processor further causes the at least one processor to:

count a number of times that a preset character string in text information of the subtitle in the same timestamp among the obtained subtitles is duplicated, wherein the preset character string is a character string consisting of a preset number of characters ranked higher in a sequential order of characters in the text information;

determine whether the number of times that the preset character string is duplicated is more than a preset number of times that the preset character string is duplicated;

if so, determine that the subtitle contents in the same timestamp among the obtained subtitles are duplicated; and

otherwise, determine that the subtitle contents in the same timestamp among the obtained subtitles are not duplicated.

In one embodiment, the execution of the Instructions by the at least one processor further causes the at least one processor to:

determine whether the obtained subtitles are graph subtitles, before the determining module determines whether the subtitle contents in the same timestamp among the obtained subtitles are duplicated; and

if so, identify characters from the graph subtitle, and obtain the text information in the graph subtitle.

In one embodiment, the execution of the instructions by the at least one processor further causes the at least one processor to:

determine whether the obtained subtitles are graph subtitles, before the determining module determines whether the subtitle contents in the same timestamp among the obtained subtitles are duplicated; and

the execution of the instructions by the at least one processor further causes the at least one processor to:

obtain a mode in which a left-eye image, and a right-eye image in the same picture of the 3D video are arranged, if a determination result of the second graph subtitles determining module is that the obtained subtitles are graph subtitles, wherein the arrangement mode is a vertical arrangement mode or a horizontal arrangement mode;

divide the graph subtitles in the same timestamp among the obtained subtitles into two halves according to the obtained arrangement mode;

compare images in the two halves of the graph subtitles in the same timestamp in the obtained subtitles, and to determine a graph similarity;

determine whether the determined graph similarity is more than or equal to a preset similarity;

if so, determine that that the subtitle contents in the same timestamp among the obtained subtitles are duplicated; and

otherwise, determine that that the subtitle contents in the same timestamp among the obtained subtitles are not duplicated.

### Fourth Embodiment

Based upon the same inventive idea, an embodiment of the disclosure further provides a non-transitory computer-readable storage medium storing executable instructions that, when executed by an electronic device, cause the electronic device to:

obtain subtitles in at least one timestamp of the 3D video;

determine whether subtitle contents in the same timestamp among the obtained subtitles are duplicated;

if so, play the 3D video by playing the subtitles of the 3D video as 3D subtitles; and

otherwise, play the 3D video by processing the subtitles of the 3D video into 3D subtitles, and then playing the 3D subtitles.

In one embodiment, when the executable instructions executed by the electronic device, further cause the electronic device to:

calculate a matching degree between character strings In a first half of text information and a second half of text information in the subtitles in the same timestamp among the obtained subtitles;

determine whether the calculated matching degree between the character strings is more than or equal to a preset matching degree;

if so, determine that the subtitle contents in the same timestamp among the obtained subtitles are duplicated; and

otherwise, determine that the subtitle contents in the same timestamp among the obtained subtitles are not duplicated.

In one embodiment, when the executable instructions executed by the electronic device, further cause the electronic device to:

count a number of times that a preset character string in text information of the subtitle in the same timestamp among the obtained subtitles is duplicated, wherein the preset character string is a character string consisting of a preset number of characters ranked higher in a sequential order of characters in the text information;

determine whether the number of times that the preset character string is duplicated is more than a preset number of times that the preset character string is duplicated;

if so, determine that the subtitle contents in the same timestamp among the obtained subtitles are duplicated; and

otherwise, determine that the subtitle contents in the same timestamp among the obtained subtitles are not duplicated.

In one embodiment, when the executable instructions executed by the electronic device, further cause the electronic device to:

determine whether the obtained subtitles are graph subtitles, before the determining module determines whether the subtitle contents in the same timestamp among the obtained subtitles are duplicated; and

if so, identify characters from the graph subtitle, and obtain the text information in the graph subtitle.

In one embodiment, when the executable instructions executed by the electronic device, further cause the electronic device to:

determine whether the obtained subtitles are graph subtitles, before the determining module determines whether the subtitle contents in the same timestamp among the obtained subtitles are duplicated; and

when the executable instructions executed by the electronic device, further cause the electronic device to:

obtain a mode in which a left-eye image, and a right-eye image in the same picture of the 3D video are arranged, if a determination result is that the obtained subtitles are graph subtitles, wherein the arrangement mode is a vertical arrangement mode or a horizontal arrangement mode;

divide the graph subtitles in the same timestamp among the obtained subtitles into two halves according to the obtained arrangement mode;

compare images in the two halves of the graph subtitles in the same timestamp in the obtained subtitles, and to determine a graph similarity;

determine whether the determined graph similarity is more than or equal to a preset similarity;

if so, determine that that the subtitle contents in the same timestamp among the obtained subtitles are duplicated; and

otherwise, determine that that the subtitle contents in the same timestamp among the obtained subtitles are not duplicated.

The aforementioned electronic device can execute the method according to some embodiments of the disclosure, and has functional modules for executing corresponding method and advantageous thereof. For more technical details, the method according to some embodiments of the disclosure can be referred.

The electronic device according to some embodiments of the disclosure can be in multiple forms, which include but not limit to:

1. Mobile communication device, of which characteristic has mobile communication function, and briefly acts to provide voice and data communication. These terminals include smart phone (i.e. iPhone), multimedia mobile phone, feature phone, cheap phone and etc.

2. Ultra mobile personal computing device, which belongs to personal computer, and has function of calculation and process, and has mobile networking function in general. These terminals include PDA, MID, UMPC (Ultra Mobile Personal Computer) and etc.

3. Portable entertainment equipment, which can display and play multimedia contents. These equipments include audio player, video player (e.g. iPod), handheld game player, electronic book, hobby robot, and portable vehicle navigation device.

4. Server, which provides computing services, and includes processor, hard disk, memory, system bus and etc. The framework of the server is similar to the framework of universal computer, however, there is a higher requirement for processing capacity, stability, reliability, safety, expandability, manageability and etc due to supply of high reliability services.

5. Other electronic devices having data interaction function.

Those ordinarily skilled in the art can appreciate that all or a part of the operations in the methods according to the embodiments described above can be performed by program instructing relevant hardware, where the programs can be stored in a computer readable storage medium, and the programs can perform one or a combination of the operations in the embodiments of the method upon being executed; and the storage medium includes an ROM, an RAM, a magnetic disc, an optical disk, or any other medium which can store program codes.

Lastly it shall be noted that the respective embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof and these modifications or substitutions to the corresponding technical solution shall also fall into the scope of the disclosure as claimed.

What is claimed is:

1. A method for playing subtitles of a 3D video, at an electronic device with a display, the method comprising:
obtaining subtitles in at least one timestamp of the 3D video;
determining whether subtitle contents in the same timestamp among the obtained subtitles are duplicated;
if so, then playing the 3D video by playing the subtitles of the 3D video as 3D subtitles; and
otherwise, playing the 3D video by processing the subtitles of the 3D video into 3D subtitles, and then playing the 3D subtitles.

2. The method according to claim 1, wherein the determining whether the subtitle contents in the same timestamp among the obtained subtitles are duplicated comprises:
calculating a matching degree between character strings in a first half of text information and a second half of text information in the subtitles in the same timestamp among the obtained subtitles;
determining whether the calculated matching degree between the character strings is more than or equal to a preset matching degree;
if so, then determining that the subtitle contents in the same timestamp among the obtained subtitles are duplicated; and
otherwise, determining that the subtitle contents in the same timestamp among the obtained subtitles are not duplicated.

3. The method according to claim 1, wherein the determining whether the subtitle contents in the same timestamp among the obtained subtitles are duplicated comprises:
counting a number of times that a preset character string in text information of the subtitles in the same timestamp among the obtained subtitles is duplicated, wherein the preset character string is a character string consisting of a preset number of characters ranked higher in a sequential order of characters in the text information;
determining whether the number of times that the preset character string is duplicated is more than a preset number of times that the preset character string is duplicated;
if so, then determining that the subtitle contents in the same timestamp among the obtained subtitles are duplicated; and
otherwise, determining that the subtitle contents in the same timestamp among the obtained subtitle are not duplicated.

4. The method according to claim 2, wherein before it is determined whether the subtitle contents in the same timestamp among the obtained subtitles are duplicated, the method further comprises:
determining whether the obtained subtitles are graph subtitles; and
if so, then identifying characters from the graph subtitles, and obtaining the text information in the graph subtitles.

5. The method according to claim 3, wherein before it is determined whether the subtitle contents in the same timestamp among the obtained subtitles are duplicated, the method further comprises:
determining whether the obtained subtitles are graph subtitles; and
if so, then identifying characters from the graph subtitles, and obtaining the text information in the graph subtitles.

6. The method according to claim 1, wherein before it is determined whether the subtitle contents in the same timestamp among the obtained subtitles are duplicated, the method further comprises:
determining whether the obtained subtitles are graph subtitles; and
the determining whether the subtitle contents in the same timestamp among the obtained subtitles are duplicated comprises:
if the obtained subtitles are graph subtitles, then obtaining a mode in which a left-eye image, and a right-eye image in the same picture of the 3D video are arranged, wherein the arrangement mode is a vertical arrangement mode or a horizontal arrangement mode;
dividing the graph subtitles in the same timestamp among the obtained subtitles into two halves according to the obtained arrangement mode;
comparing images in the two halves of the graph subtitles in the same timestamp in the obtained subtitles, and determining a graph similarity;
determining whether the determined graph similarity is more than or equal to a preset similarity;
if so, then determining that the subtitle contents in the same timestamp among the obtained subtitles are duplicated; and
otherwise, determining that the subtitle contents in the same timestamp among the obtained subtitles are not duplicated.

7. An electronic device, comprising:
at least one processor; and
a memory communicably connected with the at least one processor for storing instructions executable by the at least one processor, wherein execution of the instructions by the at least one processor causes the at least one processor to:
obtain subtitles in at least one timestamp of the 3D video;
determine whether subtitle contents in the same timestamp among the obtained subtitles are duplicated;
if so, play the 3D video by playing the subtitles of the 3D video as 3D subtitles; and
otherwise, play the 3D video by processing the subtitles of the 3D video into 3D subtitles, and then playing the 3D subtitles.

8. The electronic device according to claim 7, wherein the execution of the instructions by the at least one processor further causes the at least one processor to:
calculate a matching degree between character strings in a first half of text information and a second half of text information In the subtitles in the same timestamp among the obtained subtitles;
determine whether the calculated matching degree between the character strings is more than or equal to a preset matching degree;
if so, determine that the subtitle contents in the same timestamp among the obtained subtitles are duplicated; and
otherwise, determine that the subtitle contents in the same timestamp among the obtained subtitles are not duplicated.

9. The electronic device according to claim 7, wherein the execution of the instructions by the at least one processor further causes the at least one processor to:
count a number of times that a preset character string in text information of the subtitle in the same timestamp among the obtained subtitles is duplicated, wherein the preset character string is a character string consisting of a preset number of characters ranked higher in a sequential order of characters in the text information;
determine whether the number of times that the preset character string is duplicated is more than a preset number of times that the preset character string is duplicated;
if so, determine that the subtitle contents in the same timestamp among the obtained subtitles are duplicated; and
otherwise, determine that the subtitle contents in the same timestamp among the obtained subtitles are not duplicated.

10. The electronic device according to claim 8, wherein the execution of the instructions by the at least one processor further causes the at least one processor to:
determine whether the obtained subtitles are graph subtitles, before the determining module determines whether the subtitle contents in the same timestamp among the obtained subtitles are duplicated; and
if so, identify characters from the graph subtitle, and obtain the text information in the graph subtitle.

11. The electronic device according to claim 9, wherein the execution of the instructions by the at least one processor further causes the at least one processor to:
determine whether the obtained subtitles are graph subtitles, before the determining module determines whether the subtitle contents in the same timestamp among the obtained subtitles are duplicated; and
if so, identify characters from the graph subtitle, and obtain the text information in the graph subtitle.

12. The electronic device according to claim 7, wherein the execution of the instructions by the at least one processor further causes the at least one processor to:
determine whether the obtained subtitles are graph subtitles, before the determining module determines whether the subtitle contents in the same timestamp among the obtained subtitles are duplicated; and
the execution of the instructions by the at least one processor further causes the at least one processor to:
obtain a mode in which a left-eye image, and a right-eye image in the same picture of the 3D video are arranged, if a determination result is that the obtained subtitles are graph subtitles, wherein the arrangement mode is a vertical arrangement mode or a horizontal arrangement mode;
divide the graph subtitles in the same timestamp among the obtained subtitles into two halves according to the obtained arrangement mode;
compare images in the two halves of the graph subtitles in the same timestamp in the obtained subtitles, and to determine a graph similarity;
determine whether the determined graph similarity is more than or equal to a preset similarity;
if so, determine that that the subtitle contents in the same timestamp among the obtained subtitles are duplicated; and
otherwise, determine that that the subtitle contents in the same timestamp among the obtained subtitles are not duplicated.

13. A non-transitory computer-readable storage medium storing executable instructions that when executed by an electronic device, cause the electronic device to:
obtain subtitles in at least one timestamp of the 3D video;
determine whether subtitle contents in the same timestamp among the obtained subtitles are duplicated;
if so, play the 3D video by playing the subtitles of the 3D video as 3D subtitles; and
otherwise, play the 3D video by processing the subtitles of the 3D video into 3D subtitles, and then playing the 3D subtitles.

14. The non-transitory computer-readable storage medium according to claim 13, wherein when the executable instructions executed by the electronic device, further cause the electronic device to:
calculate a matching degree between character strings in a first half of text information and a second half of text information in the subtitles in the same timestamp among the obtained subtitles;
determine whether the calculated matching degree between the character strings is more than or equal to a preset matching degree;
if so, determine that the subtitle contents in the same timestamp among the obtained subtitles are duplicated; and
otherwise, determine that the subtitle contents in the same timestamp among the obtained subtitles are not duplicated.

15. The non-transitory computer-readable storage medium according to claim 13, wherein when the executable instructions executed by the electronic device, further cause the electronic device to:
count a number of times that a preset character string in text information of the subtitle in the same timestamp among the obtained subtitles is duplicated, wherein the preset character string is a character string consisting of a preset number of characters ranked higher in a sequential order of characters in the text information;
determine whether the number of times that the preset character string is duplicated is more than a preset number of times that the preset character string is duplicated;
if so, determine that the subtitle contents in the same timestamp among the obtained subtitles are duplicated; and
otherwise, determine that the subtitle contents in the same timestamp among the obtained subtitles are not duplicated.

16. The non-transitory computer readable storage medium according to claim 14, wherein when the executable instructions executed by the electronic device, further cause the electronic device to:
count a number of times that a preset character string in text information of the subtitle in the same timestamp among the obtained subtitles is duplicated, wherein the preset character string is a character string consisting of a preset number of characters ranked higher in a sequential order of characters in the text information;
determine whether the number of times that the preset character string is duplicated is more than a preset number of times that the preset character string is duplicated;
if so, determine that the subtitle contents in the same timestamp among the obtained subtitles are duplicated; and
otherwise, determine that the subtitle contents in the same timestamp among the obtained subtitles are not duplicated.

17. The non-transitory computer-readable storage medium according to claim 13, wherein when the executable instructions executed by the electronic device, further cause the electronic device to:
determine whether the obtained subtitles are graph subtitles, before the determining module determines whether the subtitle contents in the same timestamp among the obtained subtitles are duplicated; and
if so, identify characters from the graph subtitle, and obtain the text information in the graph subtitle.

18. The non-transitory computer readable storage medium according to claim 13, wherein when the executable instructions executed by the electronic device, further cause the electronic device to:
determine whether the obtained subtitles are graph subtitles, before the determining module determines whether the subtitle contents in the same timestamp among the obtained subtitles are duplicated; and
when the executable instructions executed by the electronic device, further cause the electronic device to:
obtain a mode b which a left-eye image, and a right-eye image in the same picture of the 3D video are arranged, if a determination result is that the obtained subtitles are graph subtitles, wherein the arrangement mode is a vertical arrangement mode or a horizontal arrangement mode;
divide the graph subtitles in the same timestamp among the obtained subtitles into two halves according to the obtained arrangement mode;
compare images in the two halves of the graph subtitles in the same timestamp in the obtained subtitles, and to determine a graph similarity;
determine whether the determined graph similarity is more than or equal to a preset similarity;
if so, determine that that the subside contents in the same timestamp among the obtained subtitles are duplicated; and
otherwise, determine that that the subtitle contents in the same timestamp among the obtained subtitles are not duplicated.
